(19) United States
(12) Patent Application Publication
(10) Pub. No.: US 2007/0139447 A1
(43) Pub. Date: Jun. 21, 2007

(54) Mobile communication terminal and method for displaying character message selectively

(75) Inventor: Jeong-Hyo Yi, Gum-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/528,249

(22) Filed: Sep. 28, 2006

(30) Foreign Application Priority Data
Dec. 16, 2005 (KR) 2005-0124794

(51) Int. Cl. G09G 5/00

(52) U.S. Cl. 345/685; 340/7.55; 455/466

(57) ABSTRACT

A mobile communication terminal for a character message display and a method thereof are provided to enable individual configuration of a display condition and a display with respect to individual character messages, in which, a storage unit stores the character message, a display unit displays the character message on a screen according to the configured display condition, a character message display configuration unit configures display configuration information including a display option and a display condition through the display unit with respect to the individual character messages stored in the storage unit, and a control unit controls configuration of the character message display configuration unit according to a configuration input command and controlling display action of the display unit with respect to the character messages based on the configured display configuration information. Therefore, display of the corresponding character message may be selectively processed according to the display.

### CROSS-REFERENCE TO RELATED PATENT APPLICATIONS

This application claims the benefit under 35 U.S.C. § 119(a) of Korean Patent Application No. 2005-0124794, filed on Dec. 16, 2005, in the Korean Intellectual Property Office, the entire disclosure of which is hereby incorporated by reference.

### BACKGROUND OF THE INVENTION

1. Field of the Invention

The present invention relates to a mobile communication terminal receiving a character message. More particularly, the present invention relates to a mobile communication terminal selectively displaying a received or stored character message in a sliding form and a method thereof.

2. Description of the Prior Art

Generally, the technology of a mobile communication terminal provides users with voice communication with each other, in which the users are able to move freely without regard to their locations. With the recent rapid progress of mobile communication engineering in the present information-oriented society, various functions using the mobile communication terminal, in addition to voice communication, are being suggested and utilized. Similarly, with the rapid progress in wireless communication and data processing technology, the mobile communication terminal has been able to provide various functions such as internet communication, image communication, and transmission of moving picture messages, in addition to voice communication.

Additionally, as the mobile communication terminal is rapidly popularized, a large amount of communication is performed through the mobile communication terminal, which has become an essential communication means in present-day life. Among various functions of the mobile communication terminal, a function transferring a character or voice message from a person to another person is widely used, even when connection of the communication is not possible, (for example, the other person is out of a service area of the mobile communication or has switched off power of the mobile communication terminal), by utilizing the mobile communication terminal. Additionally, internet service companies provide a service transferring a character message to the mobile communication terminal through an on-line internet communication network.

When the mobile communication terminal receives a new character message, it stores the received character message and displays an icon noting that the new character message has been received. Subsequently, if a user inputs a command to read the received character message, the mobile communication terminal displays the stored character message on a screen.

However, when identifying a received character message with the conventional mobile communication terminal, identifying the corresponding contents is inconvenient, because the received character message stored in a mailbox must be identified after selecting a configured message menu.

A function displaying the received character message on the screen of the mobile communication terminal when the character message is received has been suggested to avoid such inconvenience.

FIG. 1 is a schematic flow chart showing a display method of a character message using a conventional mobile communication terminal.

As shown in FIG. 1, if the mobile communication terminal in a waiting mode (S12) receives a new character message (S14), the mobile communication terminal stores the newly received character message (SI 6).

At this moment, the mobile communication terminal displays the newly received character message on a screen in the form of a sliding character row (SI 8).

However, the character message display method of the conventional mobile communication terminal displays the newly received character message on the screen without any determination of reading rights, and therefore the character message may be read by another person, which may invade a person's privacy. Accordingly, a user's selective configuration is desirable for displaying the received or stored character message.

Further, the conventional method displays all the received character messages on the screen in the form of sliding character row regardless of a user's priority, and the user has actually a low possibility of identifying the contents of the character message being displayed on the screen. Therefore, selective display of a received or stored character message having high priority in identifying its content is desirable according to the user's actual situation in time and space.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a mobile communication terminal and a method thereof that can selectively display corresponding contents by selecting an optional character message among received or stored character messages.

The second object of exemplary embodiments of the present invention is to provide a mobile communication terminal and a method thereof that can change the configuration of a display condition with respect to corresponding character messages received or stored according to a user's requirement.

The third object of exemplary embodiments of the present invention is to provide a mobile communication terminal and a method thereof that can change the display configuration of content of a character message received or stored according to a corresponding user's situation in time and space.

The fourth object of exemplary embodiments of the present invention is to provide a mobile communication terminal and a method thereof that can change the display of individual messages such as received or stored characters, voice, multimedia, and moving picture, according to the user's optional condition of the display configuration.

In order to achieve the above objects, a mobile communication terminal according to an exemplary embodiment of the present invention comprises a storage unit that stores a message, output interface that generates the messages according to a configured output condition, message output configuration unit that configures output configuration information including an output option through the output interface and an output condition with respect to individual messages stored in the storage unit, and control unit that controls configuration of the message output configuration unit according to a configuration input command and controlling output action of the output interface based on the output configuration information with respect to the individual messages.

In an exemplary implementation, the condition of the output configuration information, for example, includes a repeat number of times of output with respect to the corresponding message selected for the output, output start time and finish time (hereafter referred to as “output time zone”), time-base output included in the corresponding message, and automatic output for the time-base output with respect to the message including time information among the messages stored in the storage unit.

Accordingly, the control unit outputs a message through the output interface corresponding to the repeat number of output, if the condition of the output configuration is the repeat number of output.

In another exemplary implementation, the control unit outputs the corresponding message through the output interface for a period configured according to an output time zone condition, if the condition of the output configuration information is the output time zone.

In still another exemplary implementation, the control unit outputs a message including the time information for a predetermined period through the output interface based on the time information included in the corresponding message configured according to a time-base output condition, if the condition of the output configuration information is the time-base output.

In a further exemplary implementation, the control unit outputs a message including time information for a predetermined period based on the corresponding time through the output interface among the entire messages stored in the storage unit according to an automatic output condition, if the condition of the output configuration information is the automatic output.

In an exemplary implementation, the message may include character, voice, multimedia, moving picture, or e-mail message.

In another exemplary implementation, the output interface may be a display unit outputting character information through a screen and/or an audio processing unit outputting voice information through a speaker.

In still another exemplary implementation, he control unit controls the display unit such that the character message is displayed as a character row on a predetermined area of the screen based on the output configuration information, if the message is a character message.

According to another object of exemplary embodiments of the present invention, a message output method of a mobile communication comprises a message stored, an output option and an output condition configured with respect to individually stored messages, and the individually stored messages are output according to the configured output option and output condition.

In an exemplary implementation, the output condition, for example, includes a repeat number of times of output corresponding to the message selected for the output, output time zone, time-base output included in the corresponding message, and automatic output for the time-base output with respect to the message including time information among the entire stored messages.

In another exemplary implementation, the output outputs a message corresponding to the repeat number of output, if the output condition is the repeat number of output.

In still another exemplary implementation, the output outputs the corresponding message for a period configured according to an output time zone condition, if the output condition is the output time zone.

In a further exemplary implementation, the output outputs a message including the time information for a predetermined period based on the time information included in the corresponding message configured according to a time-base output condition, if the output condition is the time-base output.

In an exemplary implementation, the output outputs the message including time information for a predetermined period based on the corresponding time among the entire messages stored according to an automatic output condition, if the output condition is the automatic output.

In another exemplary implementation, the message may include characters, voice, multimedia, moving picture, and e-mail messages.

According to exemplary embodiments of the present invention, display of the corresponding character message may be selectively processed according to the display condition by individually configuring the display option for a character message and display condition with respect to individual character messages after selecting the display option.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic flow chart showing a display method of a character message using a conventional mobile communication terminal.

FIG. 2 is a block diagram showing a mobile communication terminal providing a selective display configuration of a message according to an exemplary embodiment of the present invention.

FIG. 3 is a drawing showing a display area of a character message configured according to an exemplary embodiment of the present invention.

FIG. 4 is a drawing showing a corresponding menu display for the display configuration of the character message according to an exemplary embodiment of the present invention.

FIG. 5 is a drawing showing character display configuration information configured through a character display configuration unit of FIG. 2 and stored in a storage unit.

FIG. 6 is a schematic flow chart showing a message display method providing variable display configurations according to conditions of display configurations for individual messages by using a mobile communication terminal according to an exemplary embodiment of the present invention.

FIG. 7 is a more detailed flow chart of a sliding display configuration step of the display for the character message in FIG. 6.

FIG. 8 is a more detailed flow chart of a sliding display step for the character message in FIG. 6.

FIG. 9 is a more detailed flow chart of a detecting step of the sliding display configuration information in FIG. 8.

FIG. 10 is a more detailed flow chart of a manual sliding display step of the character message of FIG. 8.

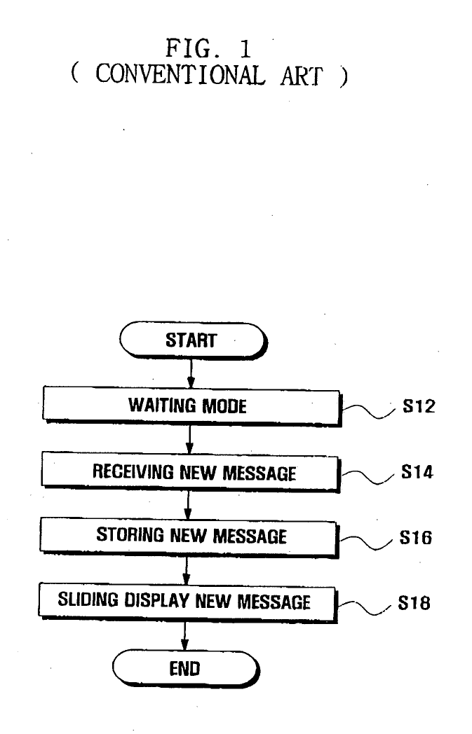

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

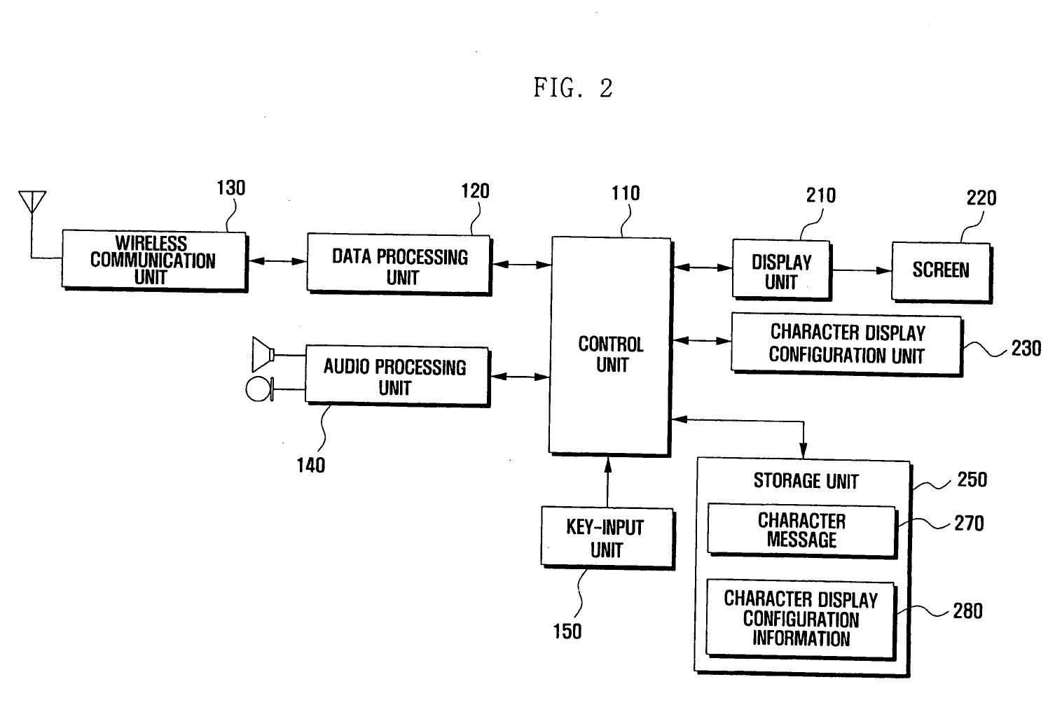

FIG. 2 is a block diagram showing a mobile communication terminal providing selective display configuration of a message according to an exemplary embodiment of the present invention.

As shown in FIG. 2, the mobile communication terminal includes a control unit 110, data processing unit 120, wireless communication unit 130, audio processing unit 140, key-input unit 150, display unit 210, screen 220, character display configuration unit 230, and storage unit 250.

The control unit 110 performs general control action of the mobile communication terminal. The control unit 110 controls data communication and voice communication with an external environment through the data processing unit 120, wireless communication unit 130, and audio processing unit 140. Additionally, the control unit 110 controls transmitting and receiving actions of a character message, voice message, multimedia message, and moving picture message to/from the external environment through a wireless channel. The control unit 110 controls display configuration of a character message received or stored according to an exemplary embodiment of the present invention and display action of the corresponding character messages according to the display configuration.

A display condition of the character message includes information such as a display option of the corresponding character message, repeat number of times of display for the corresponding character message, display time zone, and display option based on time included in the character message. Additionally, the display condition of the character message includes a schedule display configuration condition to configure the character message including the time information among the entire character messages so that the corresponding character message is displayed based on the time information included in the character message.

The data processing unit 120 includes a transmission module encoding and modulating signals for transmission through the wireless channel, and a receiving module demodulating and decoding signals received through the wireless channel. The data processing unit 120 demodulates and transfers the character message received through the wireless channel to the control unit 110, and modulates and transfers the character message to be transmitted through the wireless channel to the wireless communication unit 130.

The wireless communication unit 130 performs data transmitting and receiving functions for the wireless communication of the mobile communication terminal. The wireless communication unit 130 includes an RF transmitter transforming the frequency of signal upwards and amplifying the signal for transmission, and an RF receiver amplifying the received signal with a low noise and transforming its frequency downwards. The wireless communication unit 130 receives the character message transmitted through the wireless channel and transfers the character message to the data processing unit 120, and transfers the character message received from the data processing unit 120 through the wireless channel.

The audio processing unit 140 may be configured with a codec, which includes a data codec processing packet data and an audio codec processing audio signals such as voice. The audio processing unit 140 transforms a digital audio signal received by the data processing unit 120 to an analog signal through the audio codec, and plays the analog signal through a speaker. Additionally, the audio processing unit 140 transforms an analog audio signal input from a microphone to a digital audio signal through the audio codec and transfers the digital audio signal to the data processing unit 120 through the control unit 110. The codec may be installed separately or included in the control unit 110. The audio processing unit 140 according to an exemplary embodiment of the present invention may play audio data included in a voice message, multimedia message, and moving picture message by decoding and outputting the audio data through the speaker under the control of the control unit 110.

The key-input unit 150 includes a plurality of keys for input of number and character information, and a plurality of control keys for operation control of the mobile communication terminal. The key-input unit 150 includes keys for editing and transmitting character messages and configuration of display and/or output corresponding to individual messages received or stored. Signals of the corresponding keys are input into the control unit 110.

The display unit 210 displays status information of the mobile communication terminal on a screen 220 according to the control of the control unit 110. A liquid crystal display (LCD) may be used as the display unit 210. In an exemplary implementation, the display unit 210 may include an LCD control unit, memory for storing image data, and LCD display device. If an LCD with a touch-screen method is applied, the display unit may also operate as an input interface. The display unit 210 according to an exemplary embodiment of the present invention displays input characters on the screen 220 in an editing mode according to the control of the control unit 110. Additionally, the display unit 210 may display the corresponding character messages received or stored on the screen 220 according to a command of the control unit 110, which is input based on display configuration information. The display unit 210 preferably displays a character row of the message on a partial area of the screen 220 in a slide form when displaying the corresponding character message on the screen 220.

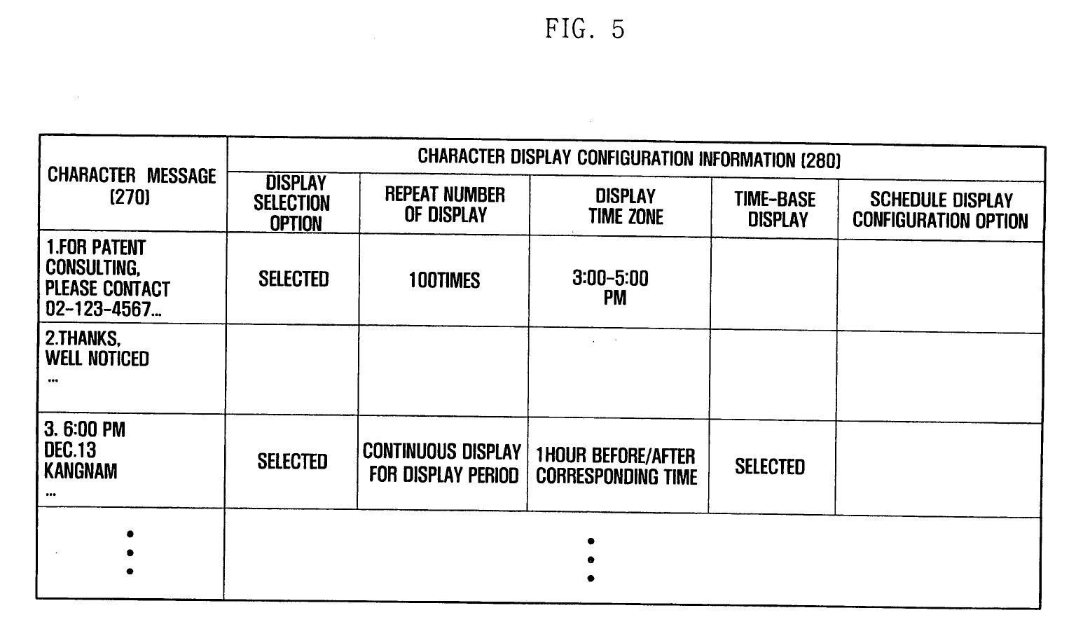

The character display configuration unit 230 configures display option of the character message received or stored by the mobile communication terminal according to an input command through the key-input unit 150. A preferred example for a display configuration of the character message will be described in FIG. 5.

The storage unit 250 may include a program memory and data memory. The program memory may include programs for general operation control of the mobile communication terminal and programs for editing and transmitting/receiving character messages according to an exemplary embodiment of the present invention. The storage unit 250 stores a character message 270 edited and/or transmitted/received through the mobile communication terminal. Additionally, the storage unit 250 stores character display configuration information 280 with reference to the display configuration of the character message configured in the character display configuration unit 230 according to an input command.

The control unit 110 displays the corresponding character message on the screen 220 of the display unit 210 corresponding to the display condition information of the character message received or stored according to the display configuration information 280 stored in the storage unit 250.

Therefore, display of the corresponding character message may selectively be processed according to the display condition by configuring the display option for each character message received or stored, and then configuring the display condition with regard to each character message with the display options selected.

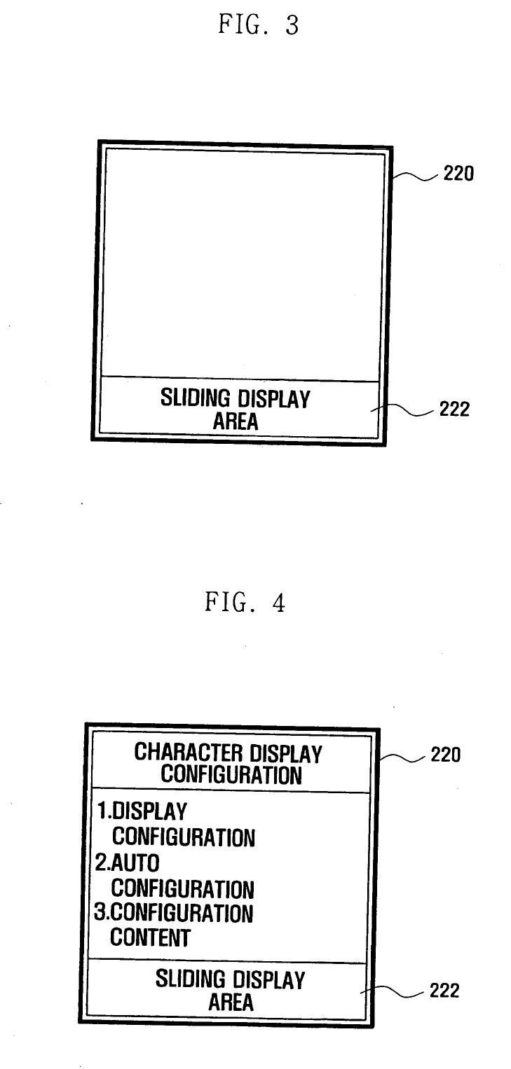

FIG. 3 is a drawing showing an example of a display area of a character message configured according to an exemplary embodiment of the present invention.

As shown in FIG. 3, in an exemplary embodiment of the present invention, an area configured to display a character message is a sliding display area 222 provided in a predetermined area at the bottom of the screen 220. Accordingly, the control unit 110 displays one or more character rows continuously sliding in the sliding display area 222. Although such sliding of the character rows preferably has a form sliding from the right to the left of the sliding display area 222, different sliding methods flowing the characters from up to down or down to up in the sliding display area 222 may also be used.

Additionally, according to an exemplary embodiment of the present invention, the character message may be displayed by converting the character message to an image. That is, the character message may be displayed on the screen by converting the character message into an image at the corresponding time instead of a configured background image. Further, if more than one character message is configured to be displayed at the same time, each character message converted to an image may also be configured to be displayed with a slide show such as a method of making the images appear/disappear sequentially or a method of turning over the pages one by one like a paper book.

FIG. 4 is a drawing showing an example of a corresponding menu display for the display configuration of the character message according to an exemplary embodiment of the present invention.

As shown in FIG. 4, by entering a character display configuration mode for a display configuration of the character message, the control unit 110 displays a configuration menu for the display configuration of the character message on the screen 220 of the display unit 210.

In the example, the display menu includes a display configuration menu (1), automatic configuration menu (2), and configuration content menu (3). The display configuration menu (1) is a menu for configuring display of the character message; the automatic configuration menu (2) is a menu for configuring automatic display of the character message based on the time information included in the character message; and the configuration content menu (3) is a menu for identifying the content of the display configuration information configured with regard to the character message.

FIG. 5 is a drawing showing an example of character display configuration information 280 configured through the character display configuration unit 230 of FIG. 2 and stored in a storage unit 250.

As shown in FIG. 5, in the character display configuration information 280, information such as a display selection option, repeat number of times of display, display time zone, time-base display, and schedule display configuration option is configured with regard to each character message 270.

The display selection option is information selecting a display option of the corresponding message. In an exemplary implementation, a first character message and a third character message among the character messages 270 are configured to be displayed.

The repeat number of display is the information indicating the number of times of repeating display for the selected character message. In an exemplary implementation, the first character message is configured to be displayed repeatedly 100 times, and the third character message is configured to be displayed continuously for a display time regardless of the repeat number of display.

The display time zone is information configuring the period of display for the selected character message. In an exemplary embodiment of the present invention, the first character message is configured to be displayed from 3:00 pm to 5:00 pm. Additionally, when displaying the display time zone according to an exemplary embodiment of the present invention, indication signals such as sound, vibration, and illumination may be output so that a user may easily identify the character message to be displayed at the display timing or before/after the display timing.

The time-base display is information configuring a display option of the corresponding character message based on the time information included in the character message. In an exemplary embodiment of the present invention, the time-base display is configured corresponding to the third character message. Accordingly, the third character message is continuously displayed on the sliding display area 222 of the screen 220 for a predetermined period based on the corresponding time information included in the third character message. In an exemplary embodiment of the present invention, the third character message is configured to be repeatedly displayed from 5:00 pm to 7:00 pm of December 13 (that is, from one hour before 6:00 pm to one hour after 6:00 pm of the same day) in a sliding form based on the time information of ‘6:00 pm December 13’ included in the third character message.

The schedule display configuration option is information configuring the corresponding character message based on the time information included in the character message, with regard to messages including time information among the entire character messages. According to an exemplary embodiment of the present invention, a state is shown in which the schedule display configuration is not selected.

In an exemplary implementation, excluding illustrated information of the character display configuration 280, conditions may freely be set or deleted according to the user's requirement, and detailed display condition of individual information may freely be configured within a predetermined range.

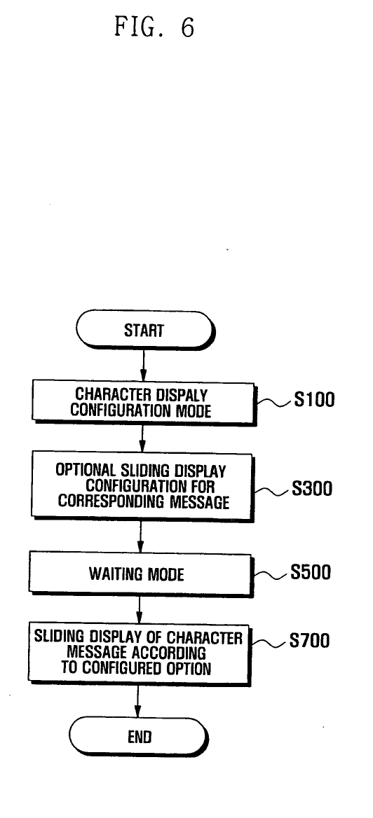

FIG. 6 is a schematic flow chart showing a message display method providing variable display configurations according to condition of the display configuration for individual messages by using a mobile communication terminal according to an exemplary embodiment of the present invention.

As shown in FIG. 6, if a command for configuring the display of the character message is input through the key-input unit 150, the control unit 110 changes an operation mode of a mobile communication terminal to a character display configuration mode (S1100).

Subsequently, the control unit 110 controls the character display configuration unit 230 according to an input command through the key-input unit 150, configures sliding display option with regard to the corresponding character message individually received or stored, and updates the character display configuration in the storage unit 250 (S300). In an exemplary implementation, the sliding display option for the configuration includes optional information such as a display selection option for a character message received or stored, repeat number of display, display time zone, time-base display, and schedule display configuration option. The control unit 110 controls the character display configuration unit 230 such that these options are configured corresponding to individual character messages by the input command.

After completing sliding display configuration of the optional character message, the control unit 110 performs operation of the mobile communication terminal in a waiting mode (S500). While in the waiting mode, if the condition corresponding to the option configured with reference to the character display configuration 280 is satisfied, the control unit 110 displays the corresponding message on the sliding display area 222 of the screen 220 in a sliding form according to the configured options (S700).

Accordingly, by displaying the individual character messages according to the detailed conditions configured in a sliding display form, the corresponding character message may selectively be displayed according to the user's requirement if confirmation of the corresponding character message is necessary, and thereby protection against an invasion of personal privacy is provided.

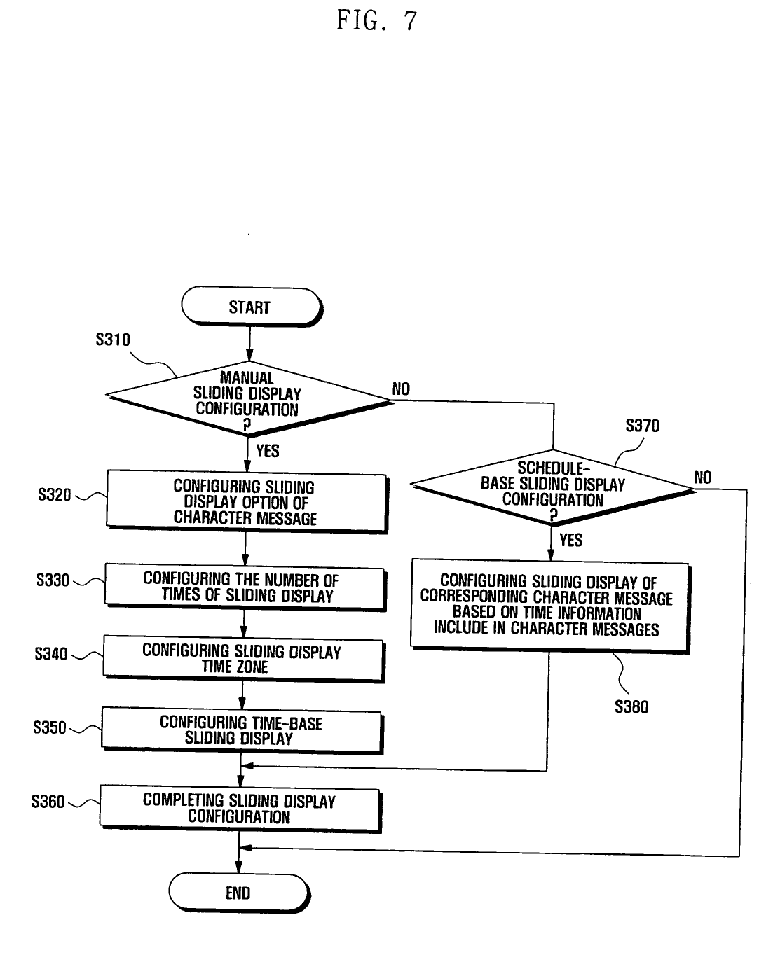

FIG. 7 is a more detailed flow chart of the sliding display configuration step (S300) of the display for the character message in FIG. 6.

In FIG. 7, in the character message display configuration mode, the control unit 110 identifies whether the mode configuration command input through the key-input unit 150 is a user's manual sliding display configuration mode for configuring the corresponding display condition for each character message (S310).

In a manual sliding display configuration mode, for example, the control unit 110 configures a display option of the corresponding character message in a sliding form according to an input command of the display option configuration by controlling the character display configuration unit 230 (S320).

After individual sliding display options are configured for the corresponding character messages, the control unit 110 configures the number of times of sliding display according to an input command of display number configuration of the corresponding character message configured with a sliding display by controlling the character display configuration unit 230 (S330).

After the display number for the corresponding character message selected for a sliding display has been configured, the control unit 110 configures the display time zone of the character message so that the character message is displayed in a sliding form according to a display time zone configuration command by controlling the character display configuration unit 230 (S340).

After the display time zone is configured for the corresponding character message, the control unit 110 configures the corresponding character message to be displayed based on the time information included in the corresponding character message selected for a sliding display according to a time-base display command by controlling the character display configuration unit 230 (S350).

If, in step S310, the character display configuration mode is not the manual sliding display configuration mode, the control unit 110 identifies whether the character display configuration mode input through the key-input unit 150 is a schedule sliding display configuration mode for displaying the corresponding character messages based on the time information included in the entire character messages received or stored (S370).

If the display configuration mode of the character message is the schedule sliding display configuration mode, the control unit 110 configures the schedule sliding display configuration mode, for a predetermined period (1 hour before and after the corresponding time in an exemplary implementation), the corresponding character message is repeatedly displayed in a sliding form based on the time information included in the entire character messages according to an input command of the schedule sliding display configuration by controlling the character display configuration unit 230 (S380).

After the above steps S350 and S380, the control unit 110 completes the sliding display configuration for each character message (S360).

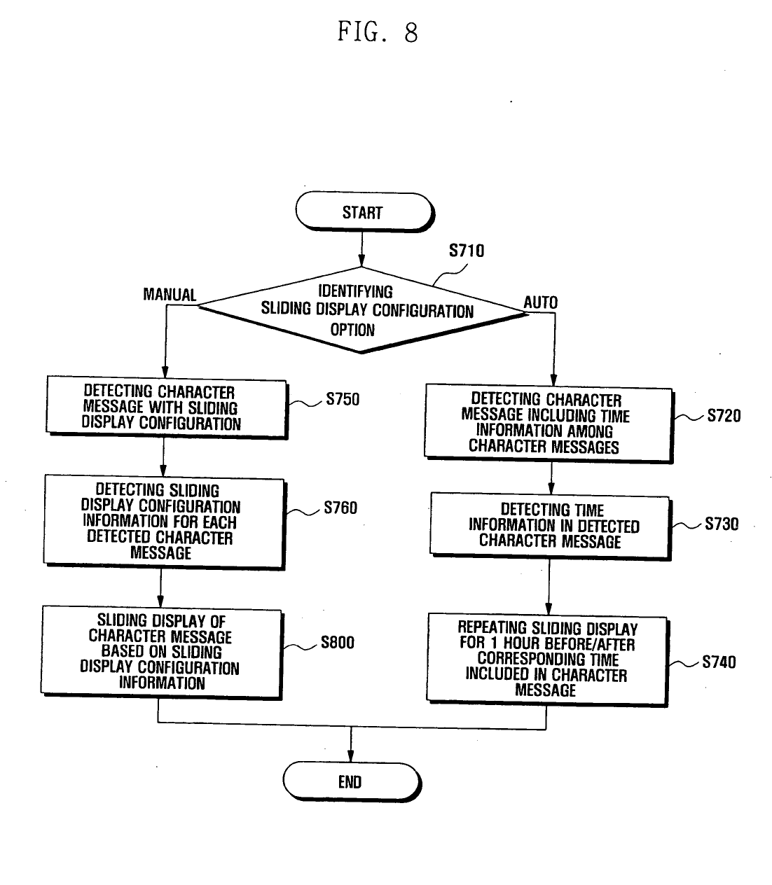

FIG. 8 is a more detailed flow chart of the sliding display step (S700) for the character message in FIG. 6.

In FIG. 8, the control unit 110 identifies whether the character sliding display option configured in the character display configuration information 280 of the storage unit 250 is a manual display configuration option or an automatic display configuration option (S710).

If the display configuration option of the character message is the automatic display configuration option, the control unit 110 identifies whether the character display configuration information 280 is configured to display the character message with a schedule display configuration. Subsequently, the control unit 110 detects those character messages that include the time information among the entire character messages 270 stored in the storage unit 250 (S720).

After detecting the character messages including the time information among the entire character messages 270, the control unit 110 detects detailed time information included in the detected character messages (S730).

After detecting the time information in the character messages, the control unit 110 repeatedly displays the corresponding character message in a sliding form from one hour before to one hour after the time included in the character message (S740). In an exemplary implementation, if two timings for character message display are overlapped, in other words, more than one character message must be displayed at the same time, the control unit 110 may display the corresponding character messages sequentially in a sliding form. In an exemplary implementation, if the times in the display time zone are overlapped partially, the control unit 110 may display the character messages by shortening the period of display repeat of the character messages that include the time information close to current time as each detected time information among the different character messages comes closer to the current time.

On the other hand, if the display configuration option of the character message is the manual display configuration option in step S710, the control unit 110 detects the character message configured for a sliding display referring to the character display configuration information 280 stored in the storage unit 250 (S750).

After detecting the character message configured for the sliding display, the control unit 110 detects information of sliding display configuration of each detected character message referring to the character display configuration information 280 (S760).

After searching the information of sliding display configuration of each detected character message, the control unit 110 displays the corresponding character message in a sliding form on the sliding display area 222 of the screen 220 according to the configured method and based on the sliding display configuration information detected for each character message (S800).

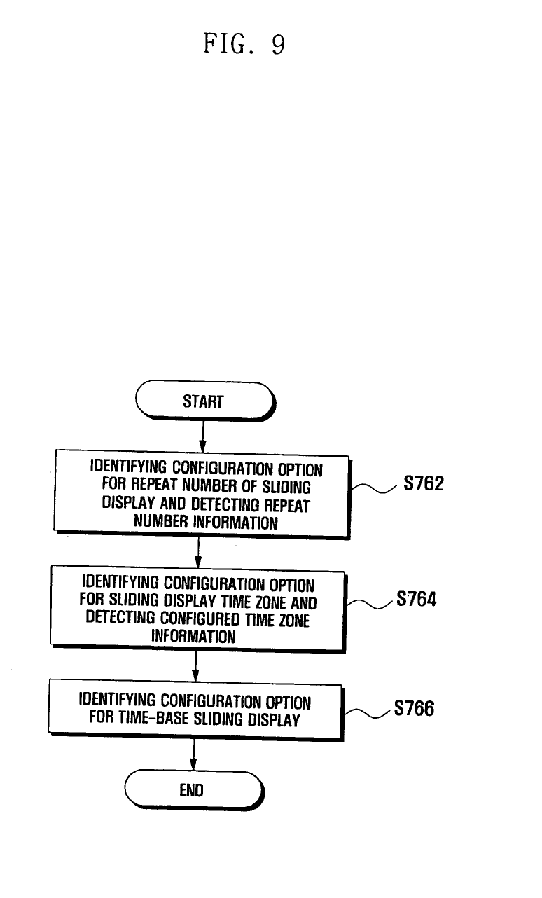

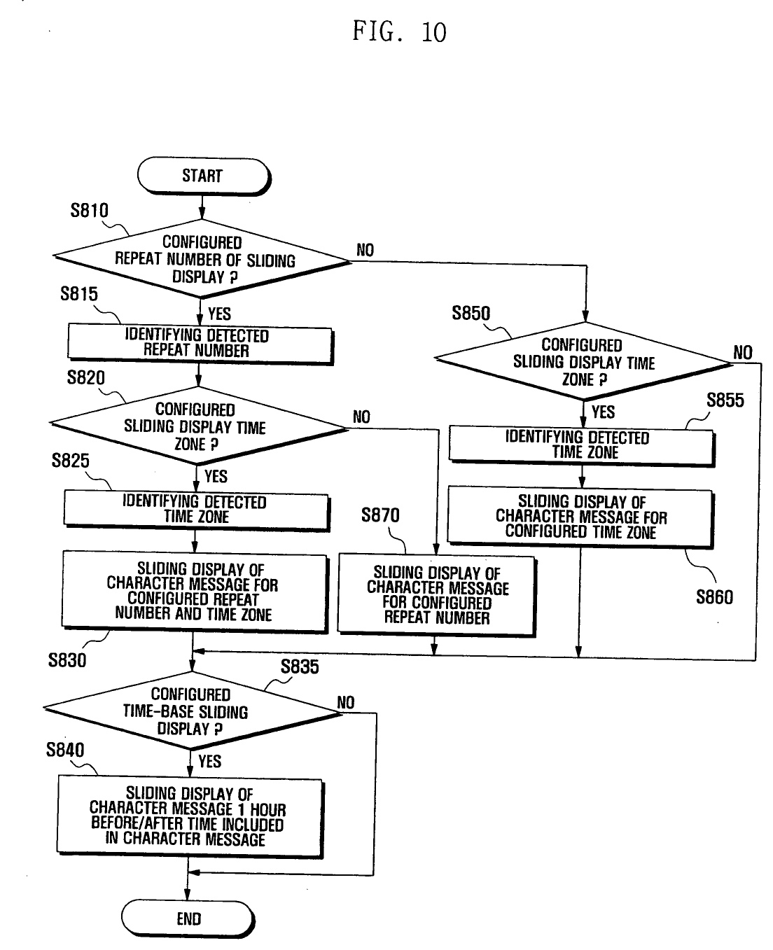

FIG. 9 is a more detailed flow chart of the detecting step (S760) of the sliding display configuration information in FIG. 8.

In FIG. 9, the control unit 110 identifies whether the sliding display configuration number is configured or not for each detected character message referring to the character display configuration information 280 and detects the configured repeat number of display accordingly (S762). After detecting the repeat number of sliding display, the control unit 110 identifies configuration of the sliding display time zone for the character messages selected for a sliding display referring to the character display configuration 280 and detects display time zone information configured accordingly (S764). After detecting the display time zone information, the control unit 110 identifies whether a time-base sliding display is configured to select the character message for a sliding display referring to the character display configuration information 280 (S766).

Subsequently, the control unit 110 performs sliding display of each corresponding character message on the sliding display area 222 of the display unit 210 according to the character display configuration information obtained by the above identification and detection steps.

FIG. 10 is a more detailed flow chart of the manual sliding display step (S800) of the character message in FIG. 8.

In FIG. 10, the control unit 110 identifies whether the repeat number of sliding display for the corresponding character message selected for the sliding display according to step S762 is configured (S810). If the repeat number of sliding display for the corresponding character message selected for the sliding display is configured, the control unit 110 identifies the configured repeat number of display detected in step S762 (S815).

Further, the control unit 10 identifies whether the sliding display time zone is configured for the corresponding character message selected for a sliding display in step S764 (S820). If the sliding display time zone is configured for the corresponding character message selected for a sliding display, the control unit 110 identifies the configured sliding display time zone information detected in step S764 (S825).

Subsequently, the control unit 110 displays the corresponding character message in a sliding form on the sliding display area 222 of the screen 220 in the display unit 210 with the configured repeat number and time zone identified in steps S815 and S825 (S830).

The control unit 110 then identifies whether the time-base sliding display is configured according to step S766 with regard to the corresponding character message configured for the repeat number of sliding display and sliding display time zone (S835). If the time-base sliding display is configured with regard to the corresponding character message configured for the repeat number of sliding display and sliding display time zone, the control unit 110 displays the corresponding character message in a sliding form on the sliding display area 222 of the screen 220 in the display unit 210 from one hour before to one hour after the time based on the time information included in the corresponding character message (S840).

On the other hand, if the sliding display time zone of the corresponding character message selected for sliding display is not configured in step S820, the control unit 10 displays the corresponding character message in a sliding form on the sliding display area 222 of the screen 220 in the display unit 210 for the configured repeat number of display according to the result in step S815 (S870). Thereafter, the control unit 10 performs step S835.

Additionally, if the repeat number of sliding display for the corresponding character message selected for the sliding display is not configured in step S810, the control unit 110 identifies whether the sliding display time zone of the corresponding character message selected for sliding display according to step S764 is configured or not (S850). If the sliding display time zone of the corresponding character message selected for sliding display is not configured, the control unit 110 performs step S835.

If the sliding display time zone of the corresponding character message selected for sliding display is configured in step S850, the control unit 110 identifies the configured sliding display time zone information detected in step S764 (S855). Subsequently, the control unit 110 displays the corresponding character message in a sliding form on the sliding display area 222 of the screen 220 in the display unit 210 for the configured time zone identified in step S855 (S860). Thereafter, the control unit 110 performs step S835.

Although examples of a character message for display configuration have been described in detail, according to exemplary embodiments of the present invention, the present invention is not limited to the illustrated examples of character message and may further be applied to messages such as voice message, multimedia message, moving picture data, and e-mail data. For example, the voice message may also be output by configuring an output condition through a speaker and output condition of the corresponding voice message.

According to exemplary embodiments of the present invention, display of the corresponding character message may selectively be processed according to the display condition by individually configuring a display option of the character message and a display condition with respect to individual character messages after selecting the display options.

Additionally, by individually configuring a detailed display condition of a sliding display with respect to corresponding character messages and by displaying the corresponding character message according to the individually configured condition, the corresponding character message may be displayed according to a selective condition required by a user when confirmation of the corresponding character message is necessary, and thereby privacy of the user can be protected.

While the invention has been shown and described with reference to certain exemplary embodiments thereof, it will be understood by those skilled in the art that various changes in form and details may be made therein without departing from the spirit and scope of the present invention as defined in the appended claims and their equivalents.

What is claimed is:

1. A mobile communication terminal comprising:
a storage unit for storing at least one message;
an output interface for generating at least one message according to a configured output condition;
a message output configuration unit for configuring output configuration information comprising an output option through the output interface and an output condition in accordance with messages stored in the storage unit; and
a control unit for controlling configuration of the message output configuration unit according to a configuration input command and controlling output action of the output interface based on the configured output configuration information in accordance with at least one of the messages.

2. The mobile communication terminal of claim 1, wherein the output condition of the output configuration information comprises at least one of a repeat number of output in accordance with a corresponding message selected for output, output time zone, time-base output in the corresponding message, and automatic output for the time-base output in accordance with the message comprising time information among the messages stored in the storage unit.

3. The mobile communication terminal of claim 2, wherein the control unit outputs a message through the output interface corresponding to the number of times configured according to the repeat number of output, if the output condition of the output configuration information comprises the repeat number of output.

4. The mobile communication terminal of claim 2, wherein the control unit outputs the corresponding message through the output interface for a period configured according to an output time zone condition, if the output condition of the output configuration information comprises the output time zone.

5. The mobile communication terminal of claim 4, wherein the control unit outputs an indication signal to identify an output of the corresponding message prior to a period based on a starting time of the corresponding message according to an output time zone condition, if the output condition of the output configuration information comprises the output time zone.

6. The mobile communication terminal of claim 5, wherein the indication signal comprises at least one of a sound, vibration, and illumination signals.

7. The mobile communication terminal of claim 2, wherein the control unit outputs a message comprising time information for a period through the output interface based on the time information in the corresponding message configured according to a time-base output condition, if the output condition of the output configuration information comprises the time-base output.

8. The mobile communication terminal of claim 2, wherein the control unit outputs a message comprising time information for a period based on the corresponding time through the output interface among the entire messages stored in the storage unit according to an automatic output condition, if the output condition of the output configuration information comprises the automatic output.

9. The mobile communication terminal of claim 1, wherein the message comprises at least one of character, voice, multimedia, moving picture, and e-mail messages.

10. The mobile communication terminal of claim 9, wherein the output interface comprises at least one of a display unit outputting character information through a screen, and an audio processing unit outputting voice information through a speaker.

11. The mobile communication terminal of claim 10, wherein the display unit is controlled by the control unit so the character message is displayed as a character row on an area of a screen based on the output configuration information, if the message comprises a character message.

12. The mobile communication terminal of claim 11, wherein the display unit is controlled by the control unit so the character message is displayed in an area of the screen in the form of a sliding character row.

13. The mobile communication terminal of claim 10, wherein the display unit is controlled by the control unit so the character message is displayed as a background image of the screen by converting the character message into an image displayable on the screen based on the output configuration information, if the message comprises a character message.

14. The mobile communication terminal of claim 13, wherein the display unit is controlled by the control unit so the character message is displayed on the screen by a slide show of converted images.

15. The mobile communication terminal of claim 1, wherein the storage unit stores and controls the output configuration information corresponding to the stored messages.

16. A message output method of a mobile communication terminal comprising:
storing at least one message;
configuring an output option and an output condition in accordance with the at least one stored message; and
outputting the at least one stored message according to the configured output option and output condition.

17. The message output method of claim 16, wherein the output condition comprises at least one of a repeat number of output corresponding to a message selected for output, output time zone, time-base output in the corresponding message, and automatic output for a time-base output in accordance with the message comprising time information among stored messages.

18. The message output method of claim 17, wherein the output step outputs a message corresponding to a number of times configured according to the repeat number of output, if the output condition comprises the repeat number of output.

19. The message output method of claim 17, wherein the output step outputs the corresponding message for a period configured according to an output time zone condition, if the output condition comprises the output time zone.

20. The message output method of claim 17, wherein the output step outputs a message comprising the time information for a period based on the time information in the corresponding message configured according to a time-base output condition, if the output condition comprises the time-base output.

21. The message output method of claim 17, wherein the output step outputs the message comprising time information for a period based on the corresponding time among the messages stored according to an automatic output condition, if the output condition comprises the automatic output.

22. The message output method of claim 16, wherein the message comprises at least one of character, voice, multimedia, moving picture, and e-mail messages.

23. The message output method of claim 22, wherein the output step displays a character message in the form of a sliding character row in an area of a screen based on the output condition, if the output condition comprises a character message.

24. A mobile communication terminal enabling a character message display, the terminal comprising:
a storage unit for storing a character message;
a display unit for displaying the character message on a screen according to a configured display condition;
a character message display configuration unit for configuring display configuration information comprising the display option and a display condition through the display unit in accordance with individual character messages stored in the storage unit; and
a control unit for controlling configuration of the character message display configuration unit according to a configuration input command and controlling display action of the display unit in accordance with the character message based on the configured display configuration information.

25. The mobile communication terminal of claim 24, wherein the display condition of the display configuration information comprises at least one of a repeat number of display corresponding to a message selected for display, display time zone, time-base display in the corresponding message, and automatic display for a time-base display in accordance with messages comprising time information among messages stored in the storage unit.

26. A character message display method of a mobile communication terminal comprising:
storing at least one character message;
configuring a display option and a display condition in accordance with the at least one stored character message; and
displaying the at least one stored character message according to the configured display option and display condition.

27. The character message display method of claim 26, wherein the display condition comprises at least one of a repeat number of display corresponding to a message selected for display, display time zone, time-base display in the corresponding message, and automatic display for time-base display in accordance with messages comprising time information among stored messages.

28. The mobile communication terminal of claim 1, wherein the messages are individually stored in the storage unit.

29. The mobile communication terminal of claim 15, wherein the output configuration information corresponding to the stored messages are stored separately.

30. The message output method of claim 16, wherein the storing comprises individually storing a plurality of messages.

31. The character message display method of claim 26, wherein the storing comprises individually storing a plurality of messages.
